(19) United States
(12) Patent Application Publication
(10) Pub. No.: US 2014/0358751 A1
(43) Pub. Date: Dec. 4, 2014

(54) Utility Cost Engine

(71) Applicant: eSight Energy Limited, Swavesey (GB)

(72) Inventor: Simon Durrant, Somersham (GB)

(73) Assignee: eSight Energy Limited, Swavesey (GB)

(21) Appl. No.: 14/289,806

(22) Filed: May 29, 2014

Related U.S. Application Data
(60) Provisional application No. 61/828,423, filed on May 29, 2013.

(51) Int. Cl. G06Q 50/06; G06Q 30/04

(52) U.S. Cl. CPC G06Q 50/06; G06Q 30/04
USPC 705/34

(57) ABSTRACT

A utility cost engine for creating a contract cost template for a utility contract having a plurality of billing features, is disclosed. The cost engine preferably comprises a computer system including a display with a graphic user interface, and a design tool accessible by the computer system by a user via the interface and having stored therein a plurality of pre-programmed entities used to calculate cost. A user accesses the design tool from the computer system and selects a plurality of graphically displayed entities based on corresponding contract billing features, adding each selected entity to a base to form a contract template, and saving the formed template. Other uses for the engine such as utility monitoring and management, cost and billing verification, building automation, and informational display (e.g., building dashboard) are also disclosed.

### TECHNICAL FIELD OF THE INVENTION

The present invention relates to systems, methods and services for providing and designing a utility contract cost algorithm. Specifically, the invention relates to such systems, methods and services in utility contracts, such as those for the supply of electricity, water, sewer, gas, and the like.

### BACKGROUND OF THE INVENTION

Utility use management, monitoring and verification are common practices used by entities such as corporations, universities, hospitals, facility managers, landlords, etc. The practices involve, to some extent, looking at the use of everyday commodities such as energy, water and gas by entities and determining an accurate cost of such use.

FIG. 1 is a simplified illustration of the existing relationship between supplier and user. The utility, such as electricity, is supplied to a building (B) from the supplier (S). A meter (M) within the building collects real time consumption data at, for example, 15 minute increments and reports such data to a computer server (C). The server calculates the cost of the electricity consumed. Much more can be done with this cost data.

However, because of continual fluctuating utility costs, dynamic billing procedures and the numerous billing contracts commonly used by utility companies, costs are neither easy to predict nor simple to calculate. This is especially true for entities having large facilities (e.g., a manufacturer, universities), numerous billing units (e.g., an office building), or fluctuating demands (e.g., a hospital).

The use of a computer system running a program specifically designed to calculate the cost of use for those commodities at a facility is fairly common. A program is “hardwired” with the details of a specific utility service contract, taking into account all fluctuating and fixed cost parameters, requiring only the entry of actual use data to produce an accurate cost. The scope of the contract may span from a single building to a group of buildings such as university campuses, office buildings, retail stores networks or factories. However, as the market for utility monitoring expands worldwide, the number of contracts needing to be programmed also continues to grow. Utility contract cost calculation systems have traditionally been developed individually to handle one specific contract type. The growing number of contracts makes individual development for new contracts an increasingly inefficient and expensive undertaking.

For example, an organization with a Global presence would need separate contracts for each country to manage utilities. However, individual development of separate contracts to cover the requirements for the Global markets would simply be cost prohibitive and slow to develop.

Further complicating the matter is the fact that as the local and Global marketplace for the supply of utilities becomes deregulated, the complexity of pricing structures and tariffs necessarily increases. This complexity and variation exists between suppliers within a country as well as across countries. For at least this reason, the ability to develop software to support the multitude of varying and complex pricing structures becomes cost and time prohibitive.

There is a definite need in the industry for utility purchasing entities, such as those described above, to be able to use a system which is able to respond quickly to changing pricing structures and markets. And, the use should not be limited to energy monitoring, but should also include features for energy targeting, building automation, bill verification, billing and building of dashboards. It is proposed herein that a single utility cost engine is needed which is flexible enough to handle nearly all of the contract types encountered.

A key aspect of the preferred module is that the utility cost engine is an ideal resource for energy management based on factors such as consumption and/or a specific contract cost structure. The present system and methods allow resource usage, such as energy consumption, to be closely monitored over periods of time (e.g., 15 min., days, weeks, months, etc.) to maximize benefits including cost savings and conservation efforts. For example the cost engine may be used to create a graph of energy usage by cost. A day's worth of 15 minute meter readings could be shown as a cost for each 15 minute interval. Such information could then be used by an energy manager to look at the cost of energy throughout the day with an aim of reducing cost (or even to just reduce usage) by changing when, where and how much energy is used. Where applicable, the system can assist in the decision of when to use on-sight generation of energy or when to transition between alternate energy sources (e.g., gas heating and electric heating sources). Other uses for the module, such as visualization of energy costs, billing, and verification, are also of importance and great value.

Until the invention of the present application, these and other problems in the prior art went either unnoticed or unsolved by those skilled in the art. The present inventions provide the ability to quickly, easily and inexpensively customize a utility cost calculation algorithm without sacrificing accuracy, convenience or reliability.

### SUMMARY OF THE INVENTION

There is disclosed herein systems, methods and services for providing and designing a contract cost calculation template which avoids the disadvantages of prior systems and methods while affording additional cost and operating advantages.

In a particular embodiment, a contract design tool for creating a contract cost template for a utility contract having a plurality of billing features, is disclosed. Generally speaking, the engine preferably comprises a computer system including a display and a user interface, and a design tool accessible by the computer system by a user and having stored therein a plurality of pre-programmed contract entities used to calculate cost, wherein a user accesses the design tool from the user interface of the computer system and selects a plurality of contract entities based on contract billing features, adding each selected entity to a base to form a cost calculation template, and saving the formed template.

In a specific embodiment of the utility cost engine the pre-programmed entities are displayed on the computer system as graphic icons and are selected from a group of components consisting of: meter data points, inputs, variables, tables, calculation and outputs. User-defined contract entities may also be available once defined and saved.

Further, an inventive method for generating a contract cost template for a utility contract having a plurality of billing features, is disclosed. Generally speaking, the method comprises the steps of interfacing with a contract template design tool having a plurality of pre-programmed entities used to calculate cost, selecting a first pre-programmed entity based on the utility contract, adding the first selected pre-programmed entity to a template, selecting at least one subsequent pre-programmed entity based on the utility contract, adding the subsequent pre-programmed entity to the template, and repeating the selecting and adding steps until all billing features of the utility contract are addressed.

In specific embodiments of the method, it may further comprise the step of saving the completed template, and/or the step of running data on the template to validate the saved template.

Finally, a method for calculating a utility cost at a facility is also described and claimed. The method comprises the steps of obtaining periodic meter readings at the facility, generating a contract cost template for the utility contract applicable to the facility, using the meter readings and the final template to calculate a utility cost, and displaying the calculated utility cost. The contract cost template is preferably generated by the steps of interfacing via a graphic user interface with a contract template design tool running on a computer system processor, the design tool having a plurality of pre-programmed contract entities used to calculate a cost and configured to be graphically displayed on a display coupled to the computer system processor, selecting a first pre-programmed entity based on a corresponding billing feature of the utility contract, adding the first selected pre-programmed entity to a base template to create a new template, selecting at least one subsequent pre-programmed entity based on a corresponding billing feature of the utility contract, adding the subsequent pre-programmed entity to the new template, repeating the second selecting and adding steps until all required billing features of the utility contract are graphically represented by pre-programmed contract entities as a final template, and saving the final template to the system memory.

In a specific embodiment of the disclosed method, the step of using stored table data with the meter readings and the final template to calculate a utility cost is employed. Continually updating variables used to calculate the utility cost may also be carried out in specific embodiments.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated and described in the accompanying appendix, embodiments thereof, from an inspection of which, when considered in connection with the following description, the subject matter sought to be protected, its construction and operation, and many of its advantages should be readily understood and appreciated.

FIG. 1 is a schematic illustrating a simplified utility supplier/user relationship;

FIG. 2 is a schematic of an embodiment of the present utility cost engine system;

FIG. 3 illustrates an embodiment of the Contract Designer, including an example contract calculation diagram;

FIG. 4 illustrates current contract elements for the graphic user-interface;

FIG. 5 is a flow chart illustrating operation of the processing engine; and

FIG. 6 is an example contract template.

### DETAILED DESCRIPTION OF A PREFERRED EMBODIMENT

While this invention is susceptible of embodiments in many different forms, there is shown and described in the attached appendix and will herein be further described in detail at least one preferred embodiment of the invention with the understanding that the present disclosure is to be considered as an exemplification of the principles of the invention and is not intended to limit the broad aspect of the invention to any of the specific embodiments described or illustrated.

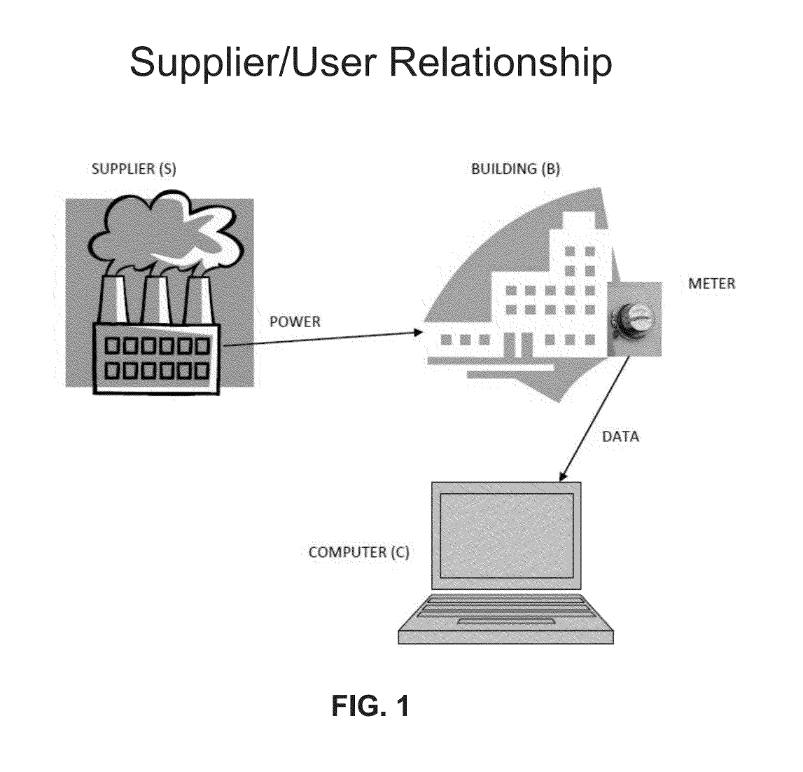

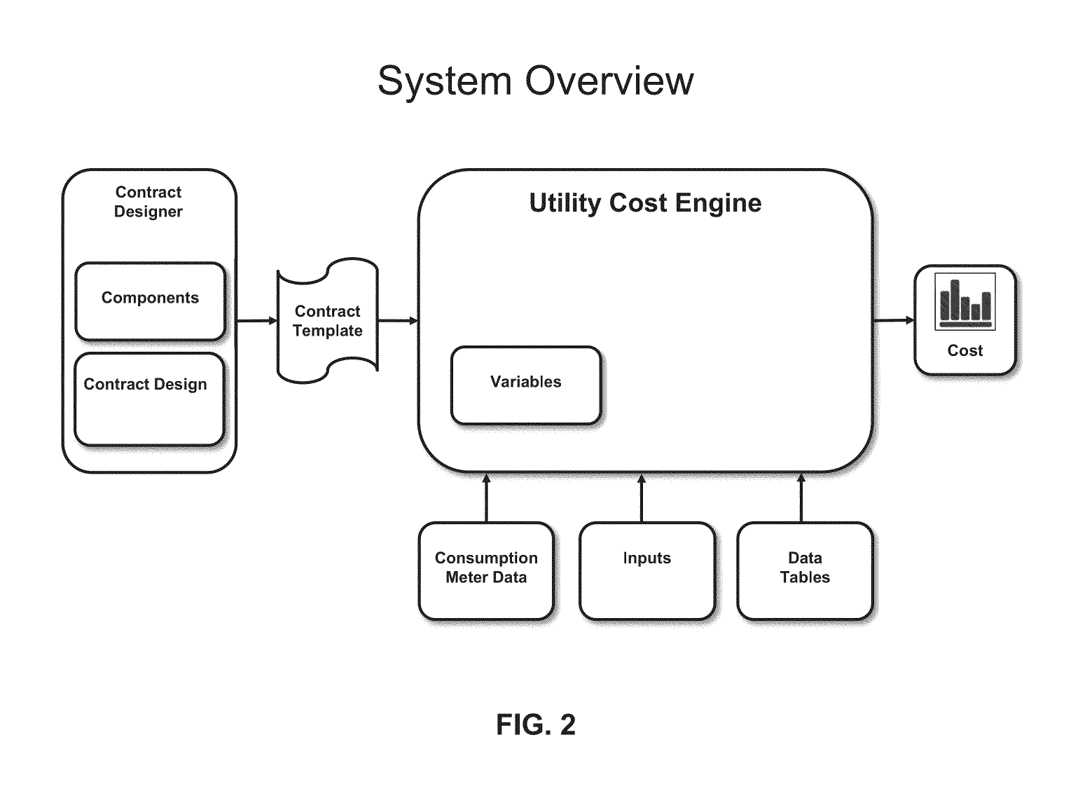

Referring to FIGS. 1-2 and the description below, there is described and illustrated a system, method and service for generating and using a contract template. The particular embodiments specifically reference energy contracts for modeling. In fact, while all these embodiments are directed to energy utility cost calculations, it should be understood that the principles of the invention can be more broadly applied to any utility service, as well as other types of fluctuating service agreements, as long as specific billing entities can be accurately defined.

It should be further understood that while the following is a detailed description of aspects of the inventive system, method and design module, not every embodiment of the invention will include every aspect, feature or functionality described below.

There are numerous features of the system which set it apart from prior energy and utility monitoring systems. A preferred utility cost engine of the present disclosure should:
1. Allow contracts to be defined by internal staff and selected resellers and end users.
2. Include pre-built contracts which are predefined and which can be upgraded by the installation process.
3. Allow at least 50% and preferably about 95% of contracts encountered to be designed and built with the contract design tool.
4. Allow the import of contract data and tables from a CSV file.
5. Allow the import and export of a contract design to an XML file.
6. Handle contracts which require price information, fixed values and also tables of data.

Reference is also made herein to a number of specific terms and phrases to explain aspects and features of the system and methods. For a better understanding of the invention, the following terms and phrases are been provided with a definition or explanation of the intended meaning.
Components—Components are the building blocks of a Contract Template and include Components for fixed price, unit charges, and the like.
Contract—A Contract specifically represents an actual contract for the supply of a utility.
Contract Design Tool—A separate MS Windows® application used to design and edit Contract Templates.
Contract History—A Contract History is based on a Contract Template and has actual prices applied. It is normally for a specific period of time, such as a contract for a year's supply.
Contract Template—This is the design of the contract which has been built from a number of Components. A Contract Template does not include actual prices, just the design of the contract structure.

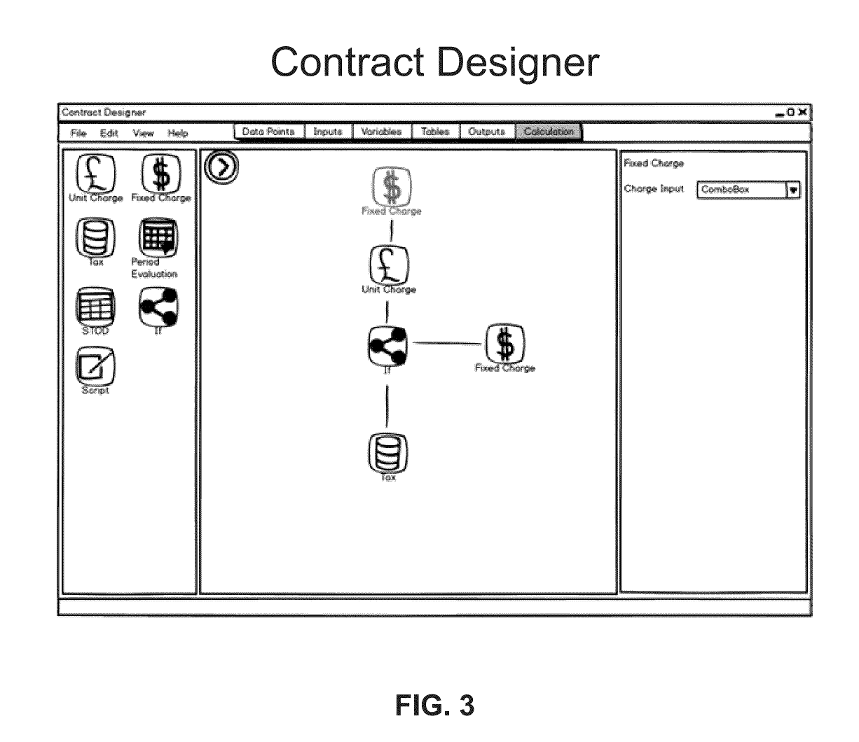

As shown in FIG. 3, Contract Templates are built using the Contract Design Tool. They are preferably saved as an XML document and can be loaded into, for example, applicant's proprietary website called eSight (See, http://www.csightenergy.com). The installation of eSight includes a number of Contract Templates.

A Contract Template is built from a number of Components. Each Component can be used to add items such as a fixed price or a unit charge to a contract. Using the Design Tool, the Components are linked to define a processing order (See FIG. 3). Some specific Components are currently developed and are not user definable. However, additional Components, with and without user-definable attributes, can be developed and added to the system. Each Component could include information of what data to request from the user when a Contract is being defined and also how to use the data to calculate price.

Once a Contact Template is complete, it is saved to the computer system memory. The Design Tool allows a user to test the Template using sample data and to view the calculated cost.

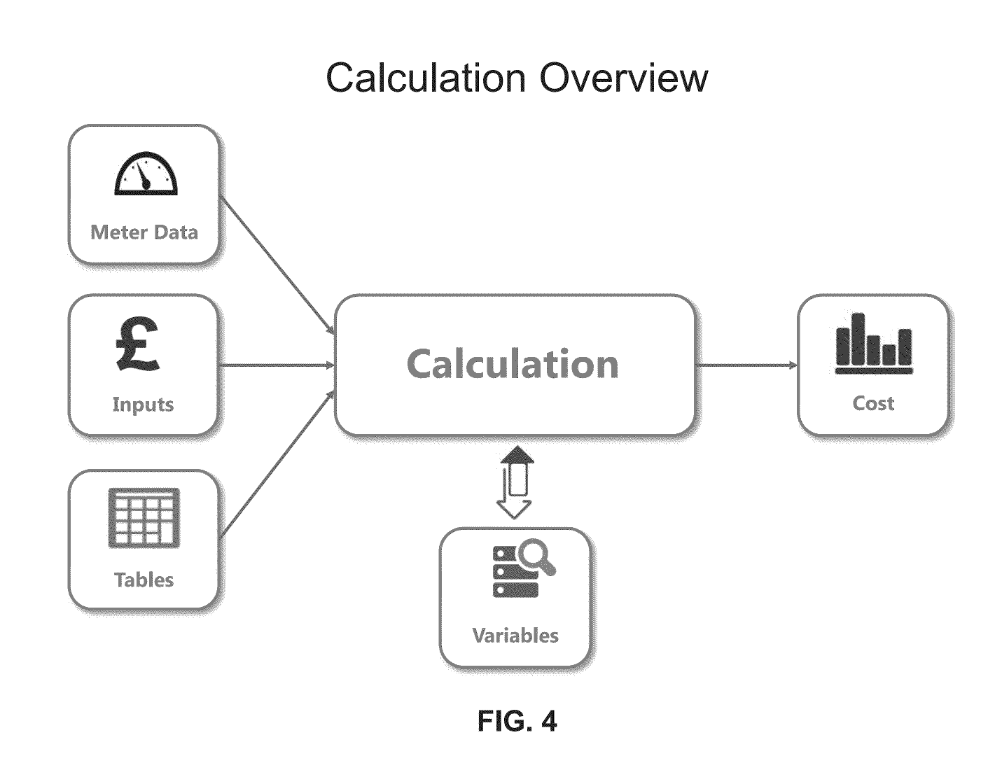

FIG. 4 provides an relationship overview of the six specific elements that currently make up a Contract Template. The current elements consist of Meter Data, Inputs, Tables, Variables, Calculation, and Outputs/Cost. These elements are described in more detail below:
Meter Data—These are the metered values required by the calculation. They can be, for example, consumption in kWh or demand in kW.
Inputs—These are values, such as a price, entered by a user when a contract template is used to create a contract. Each input should have a name as well as a value. An example of an input would be a unit price for energy or a contracted available capacity in KVA.
Tables—These are lists of data defined elsewhere within eSight. A table needs to be selected from a small number of table types and the data maintained within eSight.
Variables—These are temporary variables used within the calculation.
Calculation—Any of the mathematical processes used for the contract is a calculation. A calculation is built from one or more components, with each component defining a step in the calculation of the contract.
Outputs/Cost—These are values produced as a result of the calculation. In most cases, only the total price is required to enable energy costs to be charted or reported on. However, some areas of eSight, such as Bill Validation or Tenant Billing may require other values to be output.

Meter Data points are used to define the metering data required by the calculation. There will be a primary data point and there may also be a secondary data point. The units will also be specified. This will ensure that the data point can only be used with the correct type of metered data. It is important to note that the actual meter data point is not selected at the onset of building a template, just the fact that the contract template requires meter data points of a given type.

The following parameters are preferred for setting meter data points:

Primary Meter Data Point

Name—The name of the data point

Description—A description of the data point

Units—The units of the data point (This field is optional)

Secondary Meter Data Points (Optional)

Name—The name of the data point

Description—A description of the data point

Units—The units of the data point (This field is optional)

When a contract is applied to a meter on the meter configuration page, it is that meter that will become the primary data point. If required, the secondary data point will be specified on a Meter Reading tab. For example, if the main input is kWh, the user will navigate to the kWh meter configuration, select the contract and then define the secondary data point as the kW meter.

An Input is used to define a price or value required by the calculation. Inputs will be entered by the user when the contract template is used on a contract. Typically, an input will be used to define a price but it could also be used for other inputs such as available capacity.

The actual value of the input is specified not in the template but in an instance of a contract that is using the template. Therefore, the contract template may define a price called ‘Day Rate’. When the contract template is used to create an actual contract history entry, the value will then be entered.

In addition to prices and data values, it is possible to create sections. These are used to split the inputs into logical groups of data. For example, sections could be created called ‘Distribution Charges’ or ‘Consumption Charges’.

Inputs preferably have the following parameters:

Name—The name of the price, such as ‘Day Rate’, ‘Night Rate’ or ‘Fixed Charge’.

Reference—A reference for the charge.

Description—A description of the charge.

Mandatory—Indicates if the field should be mandatory.

Type—A number of Types are listed below:
Section—The user will need to enter the name of the section. This will be used to split inputs into sections on the user interface.
Fixed Price—The user will be required to select the currency units as major or minor.
Unit Price—The user will be required to select the currency units as major or minor.
Other Price—The user will be required to select the currency units as major or minor.
Value—This will be a numeric field. The user may optionally select the units such as kWh or kW. These will be displayed as a label.
Text—This will be a text field.
Period—A dropdown of periods including Daily, Weekly, Monthly, Quarterly, Yearly, Billing Period. A Billing Period selection would take the dates from a bill entered into the Bill Verification Module.
Tax—A dropdown of the tax rates defined in the existing Tax Rates menu option currently available.
Boolean—A tick box returning selection.
Date—A date selector.
Time—A time selector.

When each input is presented to the user to enter on an actual contract history, a reference is also preferably added. This is to allow a user to better define the input at time of use rather than when the contract was designed. For example, a contract may need a fixed charge, but the user may know this as a “Supply Charge” or “Standing Charge”. Having a reference added at time of use allows the more local name to be applied.

A table is used to hold data required by a contract. The user will be required to create a list of tables that might be required by the contract template. Either a Global Table can be added to the list or a new table specific to this contract template. A user can choose one of the existing global tables or create a new one. In the current method, the user may select “yes” for creating a Global Table and entering a name for the global table, or “no” and entering a name for the local table to be created. The type of the table can be selected from those defined in the above section.

Data for global tables is defined by a separate menu option. Where a table is specific to a contract template, the data for the table is entered when the template is used to create a Contract History.

A Variable can be used during the calculation process. It could be used to hold a running total for example. The values held in variables are temporary and are not kept after the calculation is complete. Each variable preferably has a Name and Description. However, no units are defined for variables and are all treated as full floating point numbers.

The calculation is defined by adding one or more components, each specifying a part of the calculation. In general, each component is taking metering data, a price and calculating an output value. An example of a component is a ‘Unit Cost’ component. This takes a consumption meter data point value and multiplies it against an input price value to add to the total cost output. A full list of Components is defined later in this disclosure.

The Outputs define a list of values produced by the contract. Each output will have a name, description and type. Examples of outputs might be “Total Cost,” “Total Unit Charges,” and the like.

Each Output preferably has a Name, a Description (of the value), a Type, and an Associated Input. The Type selected can be a Value (e.g., a consumption value such as a kWh), a Unit Cost, a Fixed Cost, Other Cost, Tax Cost, or Total Cost (which will be used by all other energy analysis charts when displaying cost data). The Associated Input is a dropdown menu of all inputs to allow an output such as quantity to be associated with an input such as unit rate. This may be an optional field.

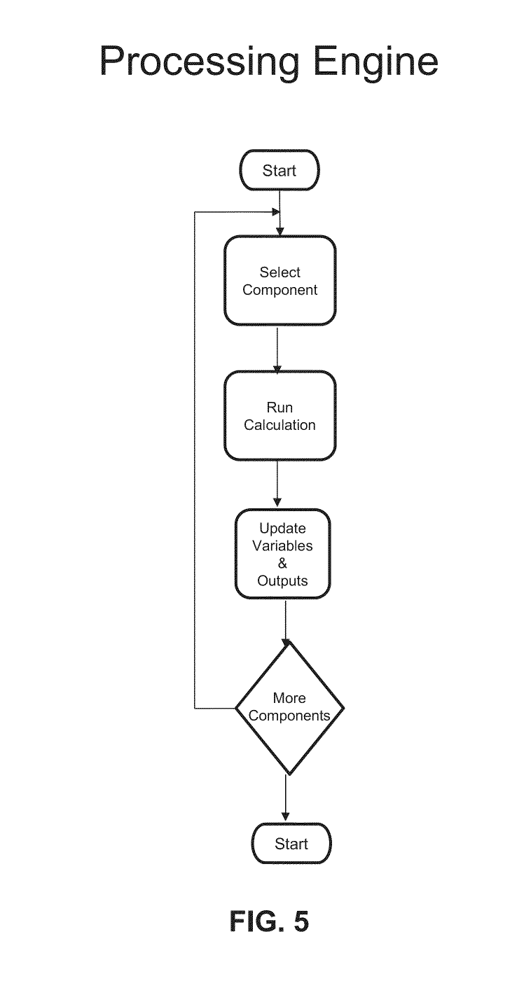

As shown in FIG. 5, the Processing Engine runs through the Contract Template beginning at the Start component and makes use of the consumption data supplied from the meter. It calculates the cost of the utility using the calculations defined in the Cost Contract Template. In addition, it makes use of parameters entered by the user such as a price for different elements of the contract. It also makes use of tables of data. These tables could store any type of data. However, a typical use would be the current day's market price for electricity or tax data, for example.

Whenever new utility consumption data is available, the associated cost can be calculated. After starting the processing of the calculation, the engine processes the first component and updates variables and outputs. The engine then decides which component should be processed next based on the design of the contract. It then moves on to the next component in the flow until the end statement is reached. During this process, the engine makes use of the Consumption data, Inputs, Tables and Variables. The Output is typically a total cost associated with the Consumption data, though many different variable can be output for other applications.

An example of a data set returned by the contract calculation, including unit quantities, unit costs and total cost, is shown below in TABLE 1.

TABLE 1

| | Day Rate | Night Rate | Day Rate | Night Rate | |
|---|---|---|---|---|---|
| | Unit | Unit | Unit | Unit | Total |
| Timestamp | Quantity | Quantity | Cost | Cost | Cost |
| 01/01/2012 08:00 | 13 | 0 | £1.56 | £0 | £1.56 |
| 01/01/2012 08:30 | 10 | 0 | £1.20 | £0 | £1.20 |
| 01/01/2012 09:00 | 0 | 20 | £0 | £1.80 | £1.80 |
| 01/01/2012 09:30 | 0 | 33 | £0 | £2.97 | £2.97 |

All outputs will be stored in the database and available for other modules without the need for further processing. It is mandatory that every contract template has at least one output called “Total Cost.”

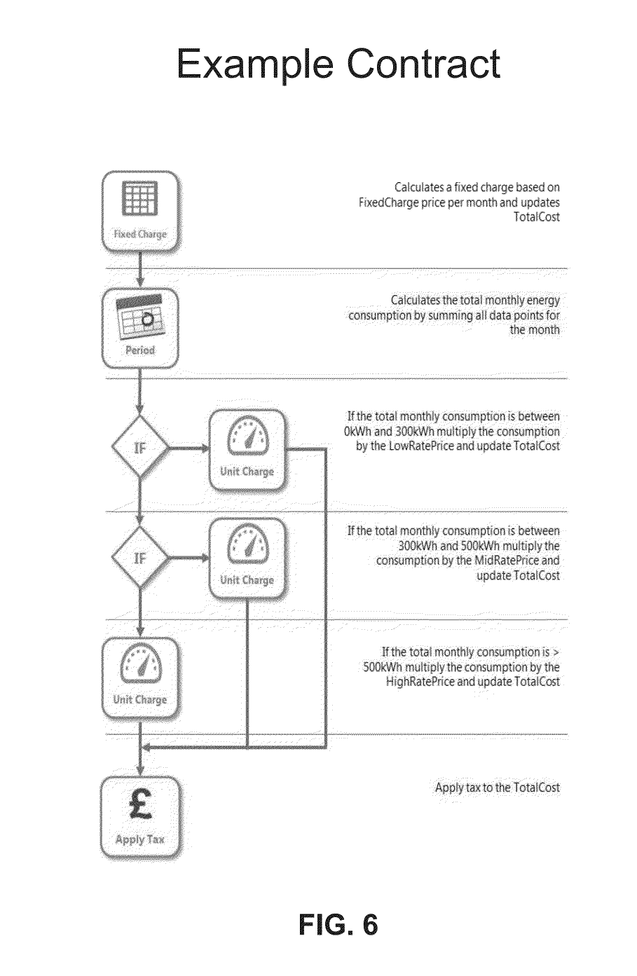

As shown in FIG. 6, the inventive system comprises a graphical user interface, which greatly enhances user-friendliness. As previously described, the user interface includes six (6) tabs with one tab for each of Meter data points, Inputs, Variables, Tables, Calculation and Outputs. All of the tabs except the Calculation tab can be built as simple tables with the ability to Add, Edit and Delete. The contents of the tables are defined in the sections above. The graphic interface will display an icon for each of the components. The icons will represent the function of the calculation. Clicking on the icon will allow the parameters associated with the components to be edited.

As noted previously, it will be possible for the user to define global tables. These may be used across many different contract templates. For example, in the UK the Climate Change Levy (CCL) table would be defined as global and be used in many different contract templates. Global tables can also be created from within eSight. The user will be able to add a new table by defining the information as previously described.

The Contract Design Tool will allow a contract template to be saved as an XML file. This is for both later editing and loading into an eSight installation. In addition, contract templates could be made available on a website for download.

The XML document would preferably be capable of storing the list of Meter data points used by the template, the list of Inputs used by the template, the list of Tables used by the template, the list of Variables used by the template, a Calculation flow diagram (including the diagram layout and the parameters for each component), and the list of all Outputs to be produced by the template.

The Fixed Charge component calculates a fixed charge for a period of time. An example of the use of this component would be to calculate a standing charge per month, such as £10 per month. There is no Input for a Fixed Charge, but a Price can be selected from a dropdown menu of all Inputs with a type of Price. Likewise, a dropdown menu of all Inputs with a type of Period is used to select the period of time. The Output to be updated must also be selected.

The Output will be calculated as the price per period. If the read frequency of the Meter Data is greater than the selected Period, the Price will be prorated. For example, at a price of £10 monthly, where the meter reading is for only a half hour in March, the Output will be the price per month (i.e., £10) divided by the number of half hours in a 30 day month (i.e., 1488) or about £0.0067204301.

The Unit Charge Component calculates a simple unit charge for an amount of consumption. An example of the use of this component would be to calculate a unit charge per kWh of consumption such as 10 p per kWh. The Inputs would be consumption kWh meter data points. The parameters of the Unit Charge are as follows:
Price—Dropdown of all Inputs with a type of Unit Price.
Register—Dropdown of all Inputs with a type of Value. Where this is used, only the consumption from that register will be used by the component.
Unit Output—Select all of the outputs to be updated with the units.
Cost Output—Select all of the outputs to be updated with the cost.

As shown in the following Example, the Calculation is made by merely multiplying the Consumption by the Price.

### Example

Price: 10 p

Consumption: 25.38 kWh

Output: 2538 p (25.38*10)

The STOD component is used to multiply consumption by a unit charge. The correct unit charge is applied based on the time of a meter reading. The Inputs are Consumption data points. The parameters of the STOD component are as follows:
Table—Select the table from those defined within the template tables.
Rates—A list of each of the rates used within the STOD table will be presented to the user. Each Rate will require the following parameters to be configured:
   Price—Dropdown of all Inputs with a type of Price.
   Unit Output—Select all of the outputs to be updated with the units.
   Cost Output—Select all of the outputs to be updated with the cost.

The Calculation is done by multiplying the Consumption by the correct Price based on the month, day and time of the meter reading.

The Period Evaluation component evaluates data over a defined period. It is used to evaluate statistical information, such as maximums, minimums, average, and the like for the selected time period. It can be used for evaluating a selected meter data point. The parameters of the Period Evaluation component are as follows:

Evaluation—Select the type of evaluation to be performed. The following options are available: Minimum, Maximum, Average and Sum.

Period—Dropdown menu of available periods such as “Yesterday,” “Last Week,” “Last Month,” “Today,” “This Week,” “This Month,” etc.
Estimate—Select an Input value which provides the estimated value which should be used up until the complete period of data is available. For example, the user would enter the typical maximum demand to be used throughout the month until the full month's data is available. Alternatively, this could be based on a typical value from past consumption.
Output—Select the variable to be updated.

Perform the evaluation on the selected meter data stream and update the output variable. If a complete set of data for the period is not available, then the estimated value will be used in place of the calculated value. The full calculation will be run again at a later time when data for the full period is available.

The Tax component, as the name implies, applies a tax rate defined within eSight to an output value and updates one or more outputs. The tax rates used are preferably standard ones defined within eSight which may be holding different tax rates for different dates. Parameters for this component are:
Net Cost—Uses a dropdown menu listing each of the output values and also all of the Variables. The user can select which value to be used within the calculation. Normally this is the Total Cost output to which the tax will be applied.
Tax Rate—Uses a dropdown menu of all Inputs with a type of Tax.
Output—Selection of the output to be updated.

The Calculation is done by multiplying the Net Cost output parameter by the tax rate and updating the selected output parameters. An example of the calculation is shown below:

### Example

Net Cost: £5,204.051

Tax: 20%

Output: Net Cost+(Net Cost×Tax):

£5,204.051+(£5,204.051×0.20)=£6,244.862

The Script component is used to evaluate a script and update one output. The Calculation is merely to evaluate the script and store the output value in the selected output variable. The parameters of the Script component include the following:
Script—The script to be evaluated. See below section for definition of the scripting language and the script designer.
Output—Select the variable or output to be updated.

An example of the Script is shown below:

### Example

MeterDataPoint.Consumption×Input/UnitPrice

The IF component can be used to direct the flow through the contract calculation. The IF component will be a simple evaluation of a formula and the output will be a true or false. There are no Inputs to be entered and the script of the IF component can have any number of parameters which will be substituted for a value at execution time. The output will always be a true or false and will direct the flow. An example IF statement is shown below:

### Example

If Variable.MaxDemand>100

A script designer can be used having a scripting language for the IF component and also the Script component. Where used in the IF component it will always result in a True or False being returned. Where it is used in the Script component it always returns a single numeric value.

The script can have any number of parameters which will be substituted for a value at execution time before evaluation.

Therefore, an example of—MeterDataPoint.Consumption×Input.UnitPrice/100 will have the two variables changed to values and becomes—53.28×0.12/100. This will then be evaluated to produce a single value to be passed out in the Output parameter.

The following variables may be used within the script:
Meter Data Point—This can be any Data Point value. The parameter will be prefixed with the term “MeterDataPoint.,” such as “MeterDataPoint.Consumption.” However, this variable would provide access to all configuration parameters associated with the meter configuration.
Input—This can be any input value. The parameter will be prefixed with the term “Input.,” such as “Input.DayRate.”
Variable—This can be any variable value. The variable will be prefixed with the term “Variable.,” such as “Variable.TotalEnergy.”
Output—This can be any output value. The parameter will be prefixed with the term “Output.,” such as “Output.TotalCost.”
Table Data—Each table type will have a dedicated function to extract the value.
DD Table—Table.Name (Type, Timestamp,Value) Value can be 1 or 2
STOD Table—Table.Name(Timestamp)
Value—A value selected from a defined list Timestamp(DataPoint)
PeriodTotal(DataPoint,Period)
Configuration—A configuration parameter for a site or meter such as DataPoint.Configuration.ReadFrequency

The script designer will include a test facility as well. This will present the user with a list of inputs to enter. After clicking a button, the script will be evaluated and an output displayed. This will either be a true or false when used in an IF component or a single value when used in a Script component.

A Contract Table can be defined as global or for use with just one contract. If the table is global it can be updated in one place for all contracts. If a table is not global, it will be defined each time the contract template is used to create a contract.

There will only be a specific list of table types that can be created. These are defined in the following sections.

A Date Dependent table is a table of values where each value is date stamped. The value will be applicable from that date up until a new value is defined at another date. For example this table type would be used to store UK Climate Change Levy (CCL) values that are defined by the government but change from time to time.

The Date Dependant Table will require two tables. The first table defines the types which can get used in the main table as shown below:

| Type | Ref |
|---|---|
| Electricity | E |
| Gas | G |

The second table will be used to define date and value pairs. The type values can only be selected from the list defined within the first table. It is possible to store two values against each entry. The second is optional. An example is shown in the table below:

| Type | Date | Value1 | Value2 |
|---|---|---|---|
| Electricity | 01/04/2009 00:00 | 0.47 | 1 |
| Electricity | 01/04/2008 00:00 | 0.456 | 2 |
| Electricity | 01/04/2007 00:00 | 0.441 | 2 |
| Electricity | 01/04/2000 00:00 | 0.43 | 2 |
| Gas | 01/04/2009 00:00 | 0.164 | 1 |
| Gas | 01/04/2008 00:00 | 0.159 | 1 |
| Gas | 01/04/2007 00:00 | 0.154 | 1 |
| Gas | 01/04/2000 00:00 | 0.15 | 1 |

A STOD table will be used to define rate switching times. This table comes with an applicable date range. All of the other tables are applicable for the defined date range.

| Name | From |
|---|---|
| 2011 | 01/01/2011 |
| 2012 | 01/01/2012 |

Each of the following tables will be repeated to each of the entries in the above history table.

The rate table will list all of the rates used in the STOD table:

| Rate | Value |
|---|---|
| Day Rate | 12 |
| Night Rate | 10 |

The STOD table will list the switching times. Only rates from the rates table can be selected:

| | From | To | From | To | From | To |
|---|---|---|---|---|---|---|
| Rate | Month | Month | Day | Day | Time | Time |
| Day Rate | Jan | Dec | Mon | Fri | 07:00 | 21:00 |
| Night Rate | Jan | Dec | Mon | Fri | 21:00 | 07:00 |
| Day Rate | Jan | Dec | Sat | Sun | 08:00 | 17:00 |
| Night Rate | Jan | Dec | Sat | Sun | 17:00 | 08:00 |

An exceptions table will list any exceptions to the STOD table.

| | From | To | |
|---|---|---|---|
| Date | Time | Time | Rate |
| 01/01/2013 | 00:00 | 00:00 | Night Rate |
| 31/12/2014 | 00:00 | 00:00 | Night Rate |

The Implementation of the Utility Cost Engine will now be explained.

With respect to contract maintenance, a facility could be added to a website such as eSight to add or delete contract templates. The templates will have been created within the design tool and then uploaded into eSight. The following parameters will be entered for a contract template:

Name The name of the Contract Template

Description A description for the Contract Template

Language The language for the Contract Template (Optional).

In addition, when a contract template is uploaded into eSight, the following parameters can be specified:

Supplier The supplier the contract is designed for (Optional)

Path The path that the Contract Template is associated with (Optional)

Fuel Type The Fuel Type that the contract is intended for use with (Optional)

It should not be possible to add a contract template that requires a global table unless that table is already present.

As to Global Table Maintenance, a facility will exist to add, edit or delete global tables. It will not be possible to remove global tables if they are used by a contract template.

As within a current eSight implementation, a contract is created to hold the pricing information for each year or duration of a contract. A contract has within it a number of history entries for each year or duration of the pricing. Again, each contract history entry can be a different contract type. The meter is attached to a contract and a contract has one or more history entries. All of this functionality remains the same.

Since the design of the contract template is defined by the user, the user interface for defining the prices and other information for a history entry needs to be dynamic. The user interface will have a number of tabs as defined below.

As to the “Inputs” tab, all Inputs defined in the Contract Template will be listed. They will be broken down into the sections defined within the inputs table. Since there could be any number of input values required, they can be presented in a list. A typical list for a two rate contract could be:

| | |
|---|---|
| Fixed Charges | Section name |

| | |
|---|---|
| Fixed Charge | £100 |

| | |
|---|---|
| Unit Charges | Section name |

| | |
|---|---|
| Day Rate | 20 p |
| Night Rate | 10 p |

The remaining tabs will be for any non-global table data. This is where a table of data is required for this contract only as any global tables will be defined elsewhere within eSight.

Since there are only a small number of defined table types, each type will have its own user interface design and associated database table. The table types are defined in the above Section.

As to Contract Errors, it is possible that a scripting component or an IF component could generate a runtime error. An example of this would be to try and divide by zero. There may also be other errors such as where a secondary data point is not specified. Such errors will be logged within the Event Log.

Where an error exists, no Output values would be saved.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A utility cost engine for use with a contract having a plurality of billing features, the cost engine comprising:
a computer system including a display, a processor, memory and a user interface;
a design tool stored within the computer system memory, operated by the processor and electronically accessible to a user via the user interface; and
a plurality of pre-programmed contract entities configured to be graphically displayed on the computer system display and manipulated by the design tool;
wherein a user accesses the design tool from the computer system via the user interface and selects a plurality of contract entities based on contract billing features, adding each selected entity to a base to form a contract template which can be saved to the computer memory.

2. The utility cost engine of claim 1, wherein the pre-programmed contract entities are selected from the group consisting of: meter data points, inputs, variables, tables, calculation and outputs.

3. The utility cost engine of claim 2, wherein the pre-programmed contract entities are selected from a drop-down menu.

4. The utility cost engine of claim 2, wherein the pre-programmed contract entities are configured to be selected and electronically dragged and dropped onto a display.

5. The utility cost engine of claim 1, further comprising at least one pre-programmed contract template saved in the computer memory and accessible via the user interface.

6. A method for generating a contract cost template for a utility contract having a plurality of billing features, the method comprising the steps of:
interfacing via a graphic user interface with a contract template design tool running on a computer system processor, the design tool having a plurality of pre-programmed contract entities used to calculate a cost and configured to be graphically displayed on a display coupled to the computer system processor;
selecting a first pre-programmed contract entity based on a corresponding billing feature of the utility contract;
adding the first selected pre-programmed contract entity to a base template to create a new template;
selecting at least one subsequent pre-programmed contract entity based on a corresponding billing feature of the utility contract;
adding the subsequent pre-programmed contract entity to the new template;
repeating the second selecting and adding steps until all required billing features of the utility contract are graphically represented by pre-programmed contract entities as a final template; and
saving the final template to the system memory.

7. The method of claim 6, wherein the pre-programmed contract entities are selected from the group consisting of: meter data points, inputs, variables, tables, calculation and outputs.

8. The method of claim 6, further comprising the step of creating user-defined contract entities.

9. The method of claim 6, further comprising the step of running data on the saved final template to validate the saved template.

10. The method of claim 8, wherein the user-defined contract entities are selected from the group consisting of: meter data points, inputs, variables, tables, calculation and outputs.

11. A method for calculating a utility cost at a facility, the method comprising the steps of:
obtaining periodic meter readings at the facility;
generating a contract cost template for the utility contract applicable to the facility, wherein the contract cost template is generated by the steps of:
interfacing via a graphic user interface with a contract template design tool running on a computer system processor, the design tool having a plurality of pre-programmed contract entities used to calculate a cost and configured to be graphically displayed on a display coupled to the computer system processor;
selecting a first pre-programmed entity based on a corresponding billing feature of the utility contract;
adding the first selected pre-programmed entity to a base template to create a new template;
selecting at least one subsequent pre-programmed entity based on a corresponding billing feature of the utility contract;
adding the subsequent pre-programmed entity to the new template;
repeating the second selecting and adding steps until all required billing features of the utility contract are graphically represented by pre-programmed contract entities as a final template; and
saving the final template to the system memory;
using the meter readings and the final template to calculate a utility cost; and
displaying the calculated utility cost.

12. The method of claim 11, further comprising the step of using stored table data with the meter readings and the final template to calculate a utility cost.

13. The method of claim 11, further comprising the step of continually updating variables used to calculate the utility cost.

14. The method of claim 11, further comprising the step of running data on the saved final template to validate the saved template.

15. The method of claim 11, further comprising the step of creating user-defined contract entities.

16. The method of claim 15, wherein the user-defined contract entities are selected from the group consisting of: meter data points, inputs, variables, tables, calculation and outputs.

17. The method of claim 11, wherein the pre-programmed contract entities are selected from the group consisting of: meter data points, inputs, variables, tables, calculation and outputs.
